(19) United States
(12) Patent Application Publication
(10) Pub. No.: US 2005/0177658 A1
(43) Pub. Date: Aug. 11, 2005

(54) Data organization in a smart card

(75) Inventor: Olivier Perrinot, Paris (FR)

Correspondence Address: PEHR JANSSON, ATTORNEY AT LAW, 7628 PARKVIEW CIRCLE, AUSTIN, TX, 78731, US

(73) Assignee: Axalto SA, Montrouge (FR)

(21) Appl. No.: 10/504,447

(22) PCT Filed: Feb. 17, 2003
(86) PCT No.: PCT/IB03/00519

(30) Foreign Application Priority Data
Feb. 18, 2002 (FR) 0202313

(51) Int. Cl. G06F 13/00

(52) U.S. Cl. 710/52

(57) ABSTRACT

The solution refers to an optimization of the memory space further to a data update in a data processing device such as a smartcard (SIM). The data to be updated comes from a remote machine (SRV) communicating with the said card. This machine stores a number of data (Sn) and comprises a storing step for each type of data in different memory areas (Z2,Z3) of the said device.

### TECHNICAL FIELD

The solutions concern the optimising of the size in octets for information included in an application and the optimising of data exchange between two machines connected together through a communication network. It must be remembered that a machine is a programmable device able to process information.

Such solutions particularly apply to radio communication networks for which the pass-band is limited, particularly the digital cellular radio-communication system of the GSM type (Global System for Mobile communication). This invention is not limited to the GSM system but may extend to any type of system such as UMTS, GPRS systems, etc.

These solutions also apply especially to on-board systems in which the material constraints (memory size, time for executing the program) and/or software constraints are maximum. A system on-board may be either a cellular telephone, an electronic wizard, a smart card for an on-board system, etc.

The example taken to illustrate the invention shall be that of the smart-card of the type called SIM card (Subscriber Identity Module) of a terminal linked with a cellular digital radio-communication system of the GSM type (Global System for Mobile communication). In our example of implementation, this terminal will communicate with a server-type machine in which are stored several applications to be downloaded in the smart card.

### PRIOR ART

The on-board systems of the smart-card type store applications generally providing the user with many features. These features are likely to evolve over time and there is a problem of data downloading for updating and of installing new features on such systems.

It is already possible through a GSM-type network to download complete applications staring from a remote machine such as a server and to manage from the server their status and position in the on-board system memory. Such applications are executables developed using the common interface for the programming of the on-board systems used. This common interface is a JAVA interface in the SIM-card example.

The drawback for this solution comes from the size of the generated traffic for such downloads, a traffic that is generally hardly accepted by the networks and the present infrastructures.

It is also necessary not to disregard the memory space taken by services. These take more and more space. For instance, today, the services (indices and commands) are stored in the same block of data. Once a service is deleted, whenever the commands for a service and the related command indices are stored in a same data block, the motor must identify the type of data (command or index) before applying the shift rule attached with such type of data, which leads to heavy processing and consumes resources, a thing that is unacceptable in a smart card where the material and software constraints are maximum.

Summary of Solutions

The main aims are:
to optimise the memory space occupied by data in the card,
to reduce the size in octets of an application,
and to reduce the data traffic when there is an exchange of data between the smart-card and the server.

In order to achieve these aims, several solutions are described. Such solutions will be better understood by reading the following description, given as an example and referring to the attached drawings.

A first solution to reduce the traffic includes the following steps:
a step to gather different services features Sn,
a step to designate an Idn identifier for each Sn service,

The SIM Card storing an engine which

manages memory addresses attached to each service

and function of the received IDn identifying a service Sn, this engine finds the corresponding position of this service Sn in memory.

So, when there is an exchange of data between the smart card and the server, messages only use the identifier Idn. In this way, the message SMS doesn't include service offset addresses. Therefore, Data bytes are reduced during a communication. Moreover the division of the application into several services enables showing only one part of the application. This solution highly reduces the size of messages to be transmitted to the card. Generally, data stored in the smartcard are accessed for an update (deletion, addition, replacement of data, . . . ), an activation, a deactivation of an application, a request for questioning the card in order to know the general status of the card, etc.

A second solution is aimed at optimising the memory space further to an update of data in a data processing device, in particular a smart card (SIM), storing various types of data (OFFn, Sn). The process as per the invention includes a storing step for each type of data in different memory areas (Z2,Z3) of the said device. In this way, each area is associated with a same type of data. Thus, the same shift rule applies to all the data in the same area. When a service is deleted and a shift has to be used to optimise the memory space, the program responsible for shifting identifies the area type and applies the same shift rule to the data in this area.

A third solution to reduce the size of an application includes the following steps:
A step to designate a reference for all or part of the commands including the same information.
A writing step consisting in replacing all or part of the commands with the associated reference, the said reference being able to pinpoint on a data block storing the wanted information.

Thus the existence of references in the application avoids writing the same command “n” times in the application. It is obvious that such technique very much reduces the size in octets of an application. When the application, or a service, is downloaded from the server to the card, the data traffic is reduced. Once downloaded, the application is re-established by a data decompressing programm stored on the card. The decompressing program uses the references (i.e. the pointers). More details on this decompression process are given in the following description.

On the drawings:

FIG. 1 is a view of a computer system on which all the solutions may be applied.

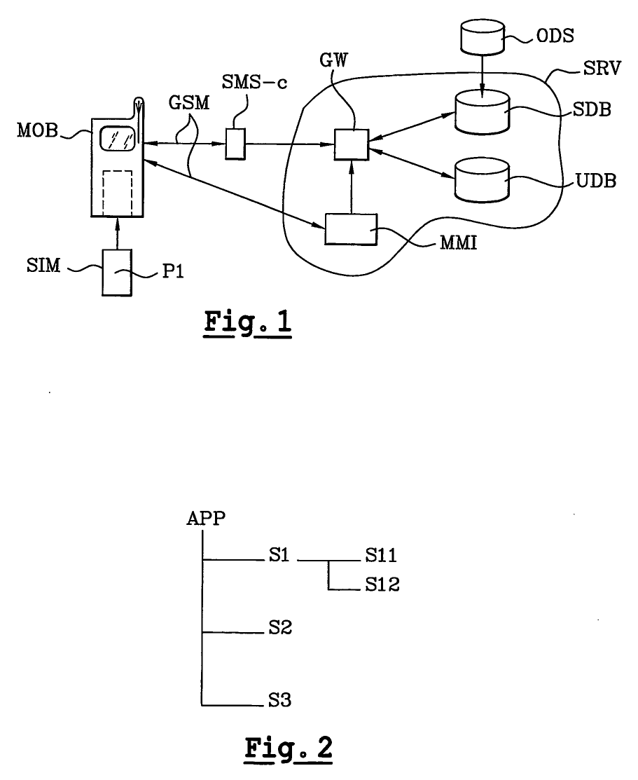

FIG. 2 is a schematic diagram of an application stored according to a tree structure on the card.

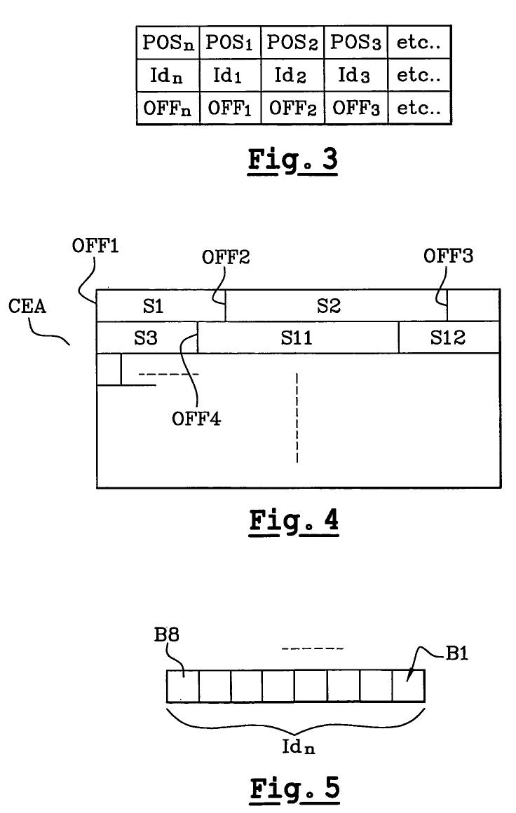

FIG. 3 is a view of an implementation example showing a table including each service, one identifier the function of which will be described in the next description part, and the respective position of the service in the tree structure of the application. This table is known by the card and the machine that communicates with the card.

FIG. 4 is a view of the service organisation in the card memory.

FIG. 5 is a schematic diagram of the bits making up an identifier.

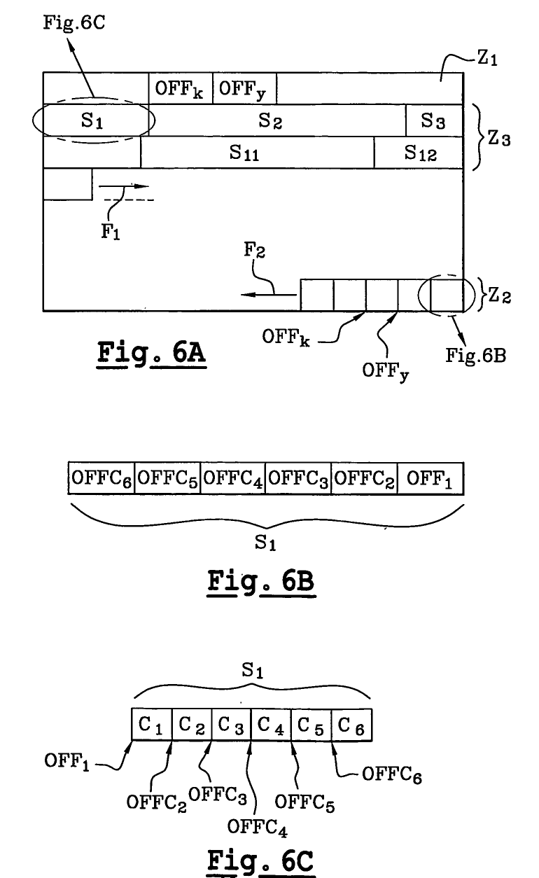

FIG. 6A is a schematic diagram of the data stored on the card; this figure shows the way in which the data is stored in the memory according to the first solution. FIGS. 6B and 6C are enlarged views of two different parts of FIG. 6A.

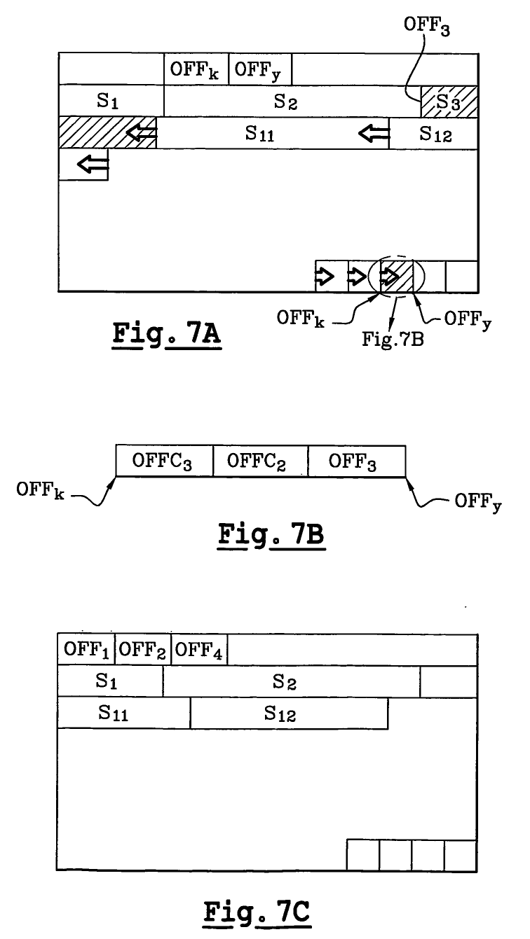

FIG. 7A is a schematic diagram of the data stored on the card; this figure shows the way in which the memory data is shifted further to a service deletion. FIG. 7B is an enlarged view of the surrounded part of FIG. 7, FIG. 7C is a view of the memory after the shift is completed.

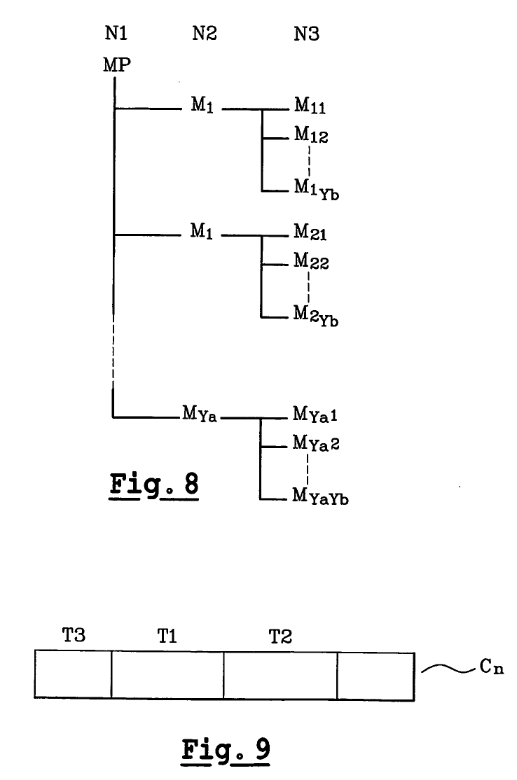

FIG. 8 shows an example that illustrates a tree structure for an application over two levels and including a number of nodes that is undetermined on the card.

FIG. 9 is a schematic diagram of the various classes of octets in a service command.

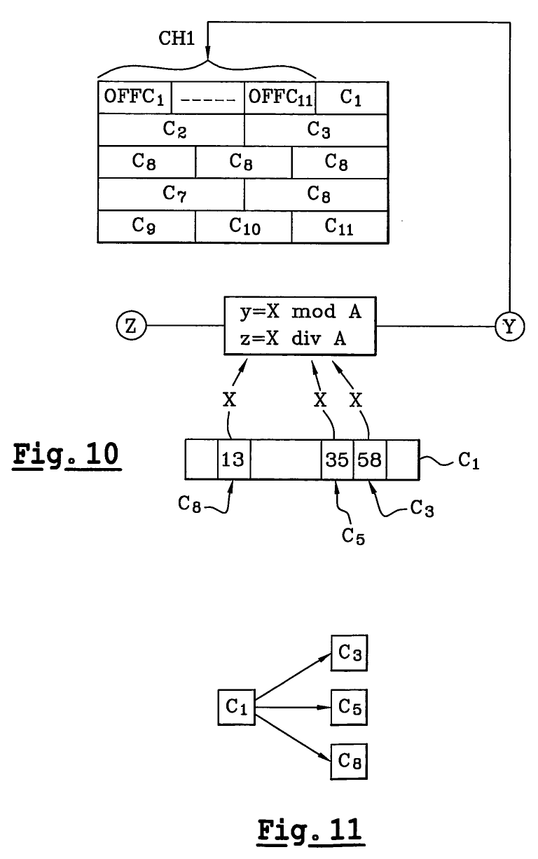

FIG. 10 is a view of a service in the memory. This figure shows a second example of execution of the second solution. This second example is placed in the very centre of a command. FIG. 11 will help understand this second example.

### DETAILED DESCRIPTION OF EXAMPLES SHOWING THE SOLUTIONS

To simplify the description, the same items shown on the drawings have the same references.

FIG. 1 shows a computer architecture with an example of execution to which all the solutions may apply. In our example of execution, this architecture includes a SIM smart card coupled with a cell phone MOB through electrical contacts (not shown). In our example, the telephone communicates with a server SRV via a GSM communication network.

In our example as shown, the SRV server includes a data base of SDB applications including available applications that can be downloaded on the SIM card.

In our example, the server also includes an MMI centre that belongs to a telephone operator. This centre is in particular responsible for taking into account requests made by users. These requests may relate to a request for updating an application that is stored on the card, or simply for installing a new application available in the SDB server. In our example of execution, the user uses his MOB terminal to communicate with this MMI centre.

In the example shown, a GW gateway is provided to interconnect the SDB data base with the MMI centre. We must underline that a gateway is an equipment (software and/or material) enabling various machines to communicate together.

In our embodiment example, an ODS application is provided to load new applications in the SDB base. In our example, this application is stored on a computer and used by the operator to create new applications and supply the SDB base with applications.

In our embodiment example, it has been chosen to store on a same server SRV the database SDB, the gateway GW and the MMI centre. However, this arrangement is not limiting; any other arrangement could have been chosen to illustrate the solutions. For instance, these three items could have been stored on three different servers.

In such architecture, applications are downloaded from the data base SDB to the SIM card. In our embodiment example, updating messages sent by the SRV server are short messages known as SMS (Short Message Service). In our embodiment example, a physical module and/or SMS-c software in inserted between the GW gateway of the SRV server and the MOB telephone. This module is able to send to the MOB telephone a message from the SRV server in the form of a network message of the SMS type. Further, means to imbed messages are provided in the server SRV gateway. Safety means are also used in order to make safe all the messages to the GW gateway or the card.

As seen previously, an application size is not small. Further, the number of SIM cards distributed over the network is very large.

As seen previously, an application size is not small. Downloading, for instance consisting in updating an application on the SIM card then consists in transmitting a number of SMS multiplied by the number of SIM cards concerned by the updating. An updating generates some traffic that some networks, for instance the GSM network, have trouble in accepting as they have not been designed to accept such traffic.

I) According to the solution, applications are not managed any more, but sub-assemblies of applications. Each sub-assembly includes a number of features offered to the user of the on-board system. Such sub-assemblies are called “Services” (Sn) in the next part of the description. A service is an assembly of commands and each command is a series of successive octets. The granularity of the application configuration is then in the service. A service may assemble a series of features.

The first solution includes the following steps:
a designation step for an identifier Idn to each Sn service,
the storing of each identifier Idn and the Sn service associated both in the computer and in the SRV server,
communicating using the identifier to identify a service.

FIG. 2 is a view of the tree structure of an application stored on the SIM card. In our embodiment example, this application includes 5 services (S1, S11, S12, S2, S3) with a respective position in the tree (POS1, POS11, POS12, POS2 POS3). Several applications may be stored on a same SIM card. As the invention principle applies in the same way for each application stored on the card, there will be a limit for describing the embodiment example of a single APP application. Similarly, the number of services taken to illustrate the invention is quite arbitrary.

Concretely, the S1 service could be a service making it possible to get news. S11 and S12 services depending of the S1 service could, for example, respectively concern sport information and political information. The S2 service could concern the consulting of consumption and the S3 service could be a game service enabling the user to play, for instance, in a lottery.

Strolling in the tree is usually made using the keys on the MOB cell phone keyboard. Whenever the user views this tree, he views for instance the service located in POS1. If he wishes to view another service, he uses the keyboard to move and place himself; for instance, on the S2 service, etc.

Preferably, each application is stored in a volatile memory, for instance of the EEPROM type, to be stored there and deleted when an updating is required.

FIG. 3 is a view of a TAB table storing the POSn position for each Sn service in the CEA memory block (FIG. 4) where the APP application is stored. The POSn position for the Sn service in the application is not an essential parameter. This parameter is generally used for sales purposes. Generally, strolling in this tree starts from the root. A commercial strategy may consist of letting memory spaces at prices that vary according to the position of the service in the tree. For instance, after selecting the APP application located at the root, and according to the size of the cell phone screen, a number of services attached to the root are visible on the screen. These services are generally the most expensive because they are the first ones visible on the screen and probably the most used.

In our embodiment example, each Sn service is known by a respective OFFn index, giving, in an octet number, the position of the first octet for the said service in relation to the first octet in the CEA memory block. This OFFn parameter is generally called “Offset” by specialists. This TAB table also stores the (IDn) identifier for each Sn service. In our example, the S1 service is located in position POS1 (OFFL) in the application; its identifier is Id1. In our example, the S2 service is located in position POS2 (OFF2) in the application; its identifier is Id2. The S3 service is located in position POS3 (OFF3) in the application; its identifier is Id3, and so on.

In our illustrated example, the information POSn, (Idn) and OFFn are shown in a table. However, any other means may be used to show this information. FIG. 4 is a schematic diagram of the service organisation in the CEA memory block. The services are concatenated, i.e. stored one after the other. A first service is stored in position POS1 with index OFF1. A second service is store in position POS2 with index OFF2, and so on. The storing order for services is indifferent.

As seen previously, each Sn service is defined by a single identifier (Idn) that characterises it. All requests for handling, for instance adding, activating, deactivating or deleting a service, or other uses this (Idn) identifier.

For instance, in order to know the status and/or the position (and eventually any information showing that the service is not on the card) of a stored service (or assumed as stored if it is not on the card) on the SIM card, it is sufficient to include in the request:
the identifier (Idn),
and a feature, or any other means, saying that the request is a question on the status and/or the position.

Another example may consist of a request to install a new service.

This request includes:

the (Idn) identifier of the service
the octets associated with this new Sn service,
a feature or any other means saying that the request concerns the addition of a service,
and, eventually, the POSn position of the service in the tree.

Another example may be a request to activate a service stored on a SIM card. Such request includes:
the service identifier
a feature or any other means saying that the request is for an activation command.

In our illustrated example, such requests for handling are messages of the AZPDU (Application Protocol Data Unit) type known by the specialists.

FIG. 5 shows a schematic diagram of an (idn) identifier, including one eight bit octet. In our embodiment example, the first bit B1 of this octet is set to show the status (activated or deactivated) of the service. This bit, depending on its value (0 or 1), shows if the service involved is activated or not. The existence of the bit in the identifier is an advantage in that it is enough to transmit the card identifier to the SDB server for this one to know the status (activated or deactivated) of the service on the card.

If the service is stored on the card and deactivated, the server activates the service by modifying the status of the bit and sends the identifier thus modified in order to activate the service on the card. Further to activation, a new menu relating to this service is visible on the MOB phone screen.

The dynamical management of the storage allocation in the application is managed through a P1 program generally called “motor” by specialists. On top of a dynamic management of the storage allocation, this motor ensures a second function, that is to interpret the CEA memory data, i.e. transforming this data into a format that is understandable for the card, i.e. in our example in the JAVA language. Also, this motor executes, after deleting a service, a shifting of the services stored in the memory in order to move them so they occupy the empty space created by the deletion. The illustration of such shifting will be described further on.

As an advantage, the result of the modification is only stored temporarily in the memory at the time of executing the application by the mobile user. In other words, only the CEA data is stored in a non-volatile way.

This dynamical management of the storage allocation may be implemented in various ways depending on the memory division. The following different versions will enable an illustration of this dynamical management.

First Version

A first way of dividing the storage may be as follows:

The memory structure is designed so that the length of the various data such as the length of a service or the length of an index, or the maximum number of commands per service, are set in order to structure in advance the memory space. The memory is divided in fixed size recordings.

Such organisation of the memory leaves a number of memory spaces unused and distributed over the memory which makes their future use difficult.

Second Version

A second version, that will be used to illustrate this solution, may consist of a special division of the memory to avoid the previous problem, i.e. the distribution of the available storage space.

According to this second version, each functional start of an Sn service may be located in the application at an OFFn position, with Y as the maximum number of positions and thus of available services in the application.

In our frustrated example, each Cn command from a service is identified by an index called OFFCn (where the service is functionally located) and a Cn Command number (relating to the service and with an incremental numbering from 0).

Let us take the size of the CEA memory dimensioned so that the indices may be coded using a single octet. Thus, in our embodiment example, if X OFFn indices are stored in the memory, they occupy obviously X octets in the memory.

This version is described with a reference to FIG. 6A. According to this version, the CEA storage space is divided into areas. In our example, there three types of data:
the OFFn indices for the services
the OFFCn indices for each command of each service
and the octet series (the commands) making up each service included in the application.

Several ways (A and B) to organise the areas may be considered:
A—A first way consists of, for instance, store in a first area the third row of table TAB (i.e. service indices) and to store in a second area subsequent blocks including the indices and the service data.
B—Another advantageous way of organising the memory is as follows. FIG. 6A is a schematic diagram of such organisation.
   A first area Z1 is reserved for storing indices ( . . . , OFFk, OFFy . . . ) at the beginning of the CEA memory. In our example, this area is for the OFFn row of table TAB visible on FIG. 3. These indices are able to point onto a second area Z2.
   The second area Z2 includes command indices for each Sn service. This second area occupies the last octets of the CEA memory. FIG. 6B is an enlarged view, in this Z2 area, of command indices for the S1 service.

In our illustrated example, this area includes 6 indices (OFF1, OFFC2, OFFC3, OFFC4, OFFC5, OFFC6). In this example, the first index allows both to find the S1 service in the CEA memory and to find the first command to be executed. The other indices are the command indices (C2,C3,C4,C5,C6) of this S1 service. FIG. 6C is an enlarged view of the S1 service visible on FIG. 6A. On this FIG. 6C can be seen the commands and indices for each command.
A third area Z3 includes the Sn services. This area starts preferably directly after area Z1. This area includes commands of each Sn service.
An empty space Z4 between the areas Z2 and Z3.

The areas Z2 and Z3 have the advantage of not having a fixed size; the size of these areas may evolve according to the user's needs. For instance, when new services are available, they may be added in the empty space Z4.

In our illustrated example, the execution of an S1 service is as follows:
The identifier (Idn) allows to find an index OFFk in the area Z1, pointing towards a data block of area Z2 including indices (OFF1,OFFC2,OFFC3, OFFC4,OFFC5,OFFC6) of the six commands of the S1 service selected.
these indices (OFF1,OFFC2,OFFC3,OFFC4,OFFC5,OFFC6) point to area Z3 where are the corresponding services. In our example, the first index OFF1 gives the index for the service inside area Z3. Thus, when the data block of area Z2 has been identified, the motor is able to find the first command to be executed, and through the indices in area Z2 of the selected service, the motor will be able to find the index of the next command to execute.

As has been said previously, one of the functions of this motor is to manage the storing of new services. In our illustrated example, the storing mechanism for a new service is as follows:
the SIM card receives the new Sn service and its identifier (Idn).

Then the motor allocates a memory space according to the division in areas. On FIG. 6A, arrows F1 and F2 are shown to indicate respectively the direction of storing the services in area Z4 and command indices for services in area Z4.

As said previously, one of the functions of this motor is also to reorganise the available space for adding new services. For instance, if a service is deleted, the memory space is automatically reorganised by the motor in order to be able to use again the memory space made free.

Let us consider, for instance, that the handling is a complete updating of the S3 service for which the identifier is Id3. FIGS. 7A and 7B give an idea respectively of the operation of service deletion and of the result obtained after the shift.

In our example, this S3 service includes three commands C1,C2,C3. FIG. 7B is an enlarged view of the data block storing indices for the three commands of this S3 service.

In our example, the updating steps for the S3 service are as follows:

Step 1

The motor receives as an entry parameter the identifier Id3 of the service to handle.

Step 2

With the table TAB and the identifier (Idn), the motor finds in Z1 a position where it will find the OFFk index of area Z2 where are stored the indices (OFF3,OFFC2,OFFC1) of the commands of the S3 service.

Step 3

The motor holds all information on the memory service localisation; it can then delete the S3 service from area Z3 (see the lined area on FIG. 7A).

Step 4

Once the data of the service are deleted from area Z3 and indices associated in area Z2, the memory includes, as well as the empty space Z4, two empty extra spaces. The motor then shifts the services of area Z3 and indices of area Z2 in order to get the two empty spaces to disappear. Arrows on FIG. 7A show the services concerned by a shift.

The division of the memory into three areas Z1,Z2,Z3 is especially advantageous at this step in the process. According to the second solution, each area is associated with a same type of data. Thus, the same shift rule applies for all data in the same area. If the services (indices and commands) had been stored in a same data block, the motor would have applied two different rules in turn for each service. This is because, when there is a shift,
a service is only subject to a shift in this data,
whereas an index is subject to a shift rule which is at the same time
   a subtraction to point to the new indices for the service commands
   and a shift in the memory.

When a service commands and the indices for the corresponding commands are stored in a same data block, the motor must identify the type of data (command or index) before applying the rule of shift associated with this type of data, which leads to extra treatments.

Thus, the memory organization into different areas Z1,Z2,Z3 simplifies the updating of a service in the memory.

The motor proceeds in this area Z3, preferably, to a shift of a length equal to the length of the deleted block. This shift is applied to all data located after index OFF4 in the Z3 area. In our illustrated example, and with a reference to FIG. 7A, the S11 service located on index OFF4 and the S12 service located on index OFF5 are shifted.

Similarly, the area Z1 is updated. In this Z1 area, indices are subject to a subtraction of a length equal to the length of the block deleted in area Z2.

Similarly, in area Z2, the motor proceeds to a shift of a length equal to the length of the deleted block. This shift is applied to all data blocks with indices lower than OFFk, i.e. blocks including command indices for services SI1 and S12 in the illustrated example. Further, in Z2, the indices of OFFCn commands are subject to a subtraction of a length equal to the length of the block that corresponds to S3 service in area Z3.

The solution is not limited to updating a service. An updating of a command is quite possible using the same principle.

In our example, before a new service is received on the card, the maximum number of commands in this Sn service is unknown. The maximum size of an Sn service or of a Cn command is also unknown. It is an advantage that during the dynamical management of the memory allocation, a calculation be made regularly or at the request of the server consisting of knowing the size of the empty space Z4.

A first way of calculating the empty space Z4 may consist of subtracting the first index of Z2 area from the first index of area Z4.

A second way to calculate the empty space Z4 may consist of a subtraction between the size ZT of the memory space ZT reserved for storing the application and the memory space occupied together by the zones Z1,Z2 and Z3 in this memory space ZT. For this, the server must have received knowledge of the ZT size of the memory space allocated to the APP application in the volatile memory. Thus, the SRV server may know the available size for storing new services for each application stored on the SIM card. This calculation may be advantageous if the application supplier changes and the new supplier does not know the status of the card.

As seen previously, the dynamical management of the memory allocation in the application is managed dynamically by the motor. Preferably, this motor is stored on the card and is developed using a common interface for the on-board systems so as to ensure an interoperability between SIM card suppliers. Storing of the motor off the card can of course be contemplated but is not advantageous in this case. For instance, this motor may be stored and executed on the MOB cell phone. However, such solution is heavy as it would force the use of a phone storing necessarily such a motor.

It is an advantage that the smart card is equipped with a JAVA virtual machine with an interface common to all the manufacturers of the SIM card of the JavaCard type. Preferably the cards are all fitted with API common interfaces for programming. The use of this solution is an advantage within a JAVA application for a SIM smart card. In such context, where the memory space saving is important, this invention provides a technical solution allowing to consume only the space that is strictly necessary while getting free of some constraints (size of commands, services, number of commands per service).

As an advantage, the computer system includes a data base UDB comprising information on each user. This data base is connected to the gateway to be able to communicate with the other components of the SRV server. This UDB base is an option. It enables in particular the storing of various information such as for instance the memory size for each card storing applications, or applications already stored on each SIM card. More generally, it includes a data base that contains the description of the status of the SIM cards. Thus, before installing a new service, the UDB server is questioned, for instance by the SDB base to know if this service is already installed or not on the card(s) in question. It can also store information regarding the version of the service installed. Preferably, this data base mainly stores the identifier (Idn), and with an advantage the position POSn of the table described in FIG. 3. The communication with this server is therefore made preferably using the service (Idn) identifier.

In our embodiment example, the identifier has a well defined structure. It may be coded with one or several octets. Ideally, the first bit of the identifier is used to define the service status. Thus, if the number of potential services is between 0 and 128, one octet is used, if it is between 0 and 128*255, we shall use 2 octets, if it is between 0 and 128*255*255, we shall use 3 octets, and so on.

In our embodiment example, and referring to FIG. 2, the service S1 includes a main menu M1 and sub-menus M21 and M22 associated to the services S11 and S12 subordinate to the node S1. A command may be for instance the sending of an SMS. For instance, if the service S1 is a service enabling the obtaining of information and the subordinate services S11 and S12 subordinate to the S1 service concern, for instance, respectively sport information and political information, the user, if he wishes to get information on sports selects item S12, and a command SMS is sent via the network.

A command may also be
tripping of telephone calls to local servers,
sending SMS messages to receive information such as weather forecast or sport results,
WAP services tripping, etc.

Generally speaking, menus may be shown in the form of trees. A tree includes nodes and leaves. In our illustrated example, menus on the tree leaves are commands called “pro-active” in that their selection generates a command from the card to the phone. Each command has a veiy exact function. In the next part of the description, a few functions will be described as examples.

On a cell phone screen, a service may be activated through menus and sub-menus as described previously. FIG. 6 is a view of a tree structure comprising in its nodes some menus and sub-menus. Different from FIG. 2, this figure shows a tree where the number of nodes is anyone. The number of the levels in the tree may also be any one. However, in order to simplify the description of this example, it has been chosen to illustrate the invention using a tree including three levels N1, N2 and N3.

Level 1 is for the main menu MP associated with the APP application.

Level 2, a level subordinate to level N1 includes ya menus. They are marked M1, M2, . . . . Mya on the figure.

And the level N3, subordinate to level N2, includes the sub-menus. Each menu (M1, M2, . . . , Mya) comprises a number yb of sub-menus. As it happens, menu M1 comprises yb sub-menus marked M11, M12, . . . , M1yb in the figure. The menu M2 comprises yb sub-menus referenced as M21, M22, . . . M2yb in the figure; and so on.

It can be then seen that the number of menus and sub-menus stored in a memory for an APP application is reached using the following mathematical formula:
Y=YA+YA×YB.

The parameter Y gives the number of positions where it is possible to install and update services independent from each other. The server gets to know this parameter which may vary from a SIM card to another.

The knowledge of this parameter Y allows, with a minimum traffic (smaller cost) to know the precise operating status of an application placed on an on-board system of the smart card type.

We have seen that the assembling step comprises a storing step for each (Idn) identifier, and some service Sn associated both in a memory (CEA) of the computer and in a machine memory (SRV). In this way, it is sufficient to send the identifier (Idn) to or out of the card. A program stored in the card and in the server enables processing this identifier and finding the related service. This program is also able to manage the service storing in a memory of the card, preferably a volatile memory so that a service updating may be achieved. After storing, the motor stores the index where the service is stored. Thus, this program is able to get back to the position of the concerned service in the CEA memory starting from its identifier Idn).

This step of identifier processing is achieved when there is a handling of the application.

With an advantage, the program is developed using a JAVA interface in order to ensure interoperability between the SIM cards distributed over the network.

It has been seen also that, during the attribution step, part of the bits of the identifier adn) is used to show the status (activated or deactivated) of the service in the device memory. It is the, sufficient for the server to question the card in order to obtain this identifier an to know its status. This identifier is used by the machine (SRV) to activate or deactivate a service on the card.

We have seen in our embodiment example that such program transforms the data related to the identifier (Idn) of the Sn service and its index OFFn in a language that can be understood by the terminal. As an advantage, it also achieves, after deleting a service, a shift of the memory stored services in order to move them so that they occupy the empty space created by the deletion.

This solution allows dividing the application into several services in order to update one or several services. This solution introduces a functional flexibility on an on-board system connected to a network, making it possible to offer new services to the system user.

This solution also enables the implementation of new solutions in marketing, targeting in a better way the wishes of users and updating for them only the services that interest them.

This solution also enables the installation of services for a given period and to replace them later.

It is clear that this solution increases the use of applications stored on the card by users as it applies better to their specific need.

The solution consisting of identifying each service allows a reduction of the messages size passing through the network.

From now on, the index management is executed on the card via a motor installed on the card. When the server questions the card, he does not need anymore to specify the service index in the card memory. The management of the service shift on updating also increases the free space for storing new services. There is no loss of memory space. This technique allows freeing the server from managing this parameter which is different for each client, and this very much simplifies the processing for the server.

Generally speaking, this solution provides a performing management system for the distribution of applications over a park of distributed systems.

II) As seen previously, the smart card has a memory space with a size that is highly limited. All the commands, made of a sequence of octets, are stored in order in the memory space. But it is often that a same command is used by several services.

Another solution consists of allocating a reference to all or part of orders including the same octets, and replacing all or part of the commands by the associated reference, the said reference being able to point to a data block including the command octets.

This solution consists of factorising the redundant information in order to reduce the service octet size.

The two following examples illustrate this solution:

### 1^{st} Example of Embodiment

In the service tree such as previously described referring to FIG. 2, the tree leaves, i.e. the nodes located at the end of the tree are proactive commands. Different from the nodes located at an intermediate level between the root and a leave, the execution of a proactive command is a command sent to the MOB cell phone.

These commands comprise octets series of different classes. In our implementation example, we shall consider three classes of octets series. FIG. 9 shows schematically the various octets classes for a command Cn.

The Three Octets Classes are as Follows:

1—A first octets class T1 identical for a type of command; these octets are therefore in the memory as many times as there are commands of this type in the memory.
2—A second octets class T2 specific to the command for its execution and which a priori is different for each command. It may happen that octet strings are often repeated from one command to another (but not for all commands, which makes them different from the class T1 octets where identical strings are repeated in all the commands of the same type).
3—A third octets class T3 calculated according to 2 types of previous octets (for instance, the length of a command is obtained using a calculation according to both types of octets T1 and T2).

Factorisation of redundant information may be implemented in various ways according to the octets class concerned. The following versions illustrate the factorisation:

Version 1:

The principle is to give the card information of the T2 type and a reference (i.e. pointer) that enables the motor to find back a constitution rule. This rule includes information of the T1 type. According to this version, the information of the T1 type is stored in the memory prior to any communication between server and card. This storing is made for instance at the time of the card customising. Information of the T3 type are then automatically calculated by the motor of the card which finally rebuilds the message with information T1 to T3 using the reference pointing on a reconstruction rule.

Version 2:

Among the information of the T2 type, it may be that octet strings are often repeated from one command to another. Then a second reference mechanism is installed so as not to duplicate the information. A command pointer A points for instance to a byte string for a command B.

Version 3:

In a service comprising an assembly of commands, it often occurs that a same command assembly is in several places in the application. In such case, a mechanism allows a division of the application in the form of modules gathering an assembly of proactive commands and allows to make wrappings between modules. Thus, a pointer stored in a service may replace a set of commands.

Version 4:

In the type T2 parameters, some strings may be dynamically found according to the path followed by the user within the application. For instance, among the proactive commands, some of them enable sending an SMS containing a message. This message differs according to the service requested (weather report, information, . . . ). Practically, the contents of the SMS will partly depend on the leave of the tree that is selected.

Another example of proactive command may be the sending of a telephone call.

A sending of a SMS is attached to a parameter that is itself linked to the selected service. The process consisting of sending an SMS message may be executed in the following way:
First, during strolling over the tree, each successively selected node (for instance the names or the octet string associated with this command) is stored for instance in a buffer memory of the card. For instance, if the user selects command C1, the name of the command is stored in the buffer memory; if he then selects a subordinate command in the tree, the name of this service is also stored in the buffer memory.
If the user selects a tree leave, this calls for the execution of a proactive command, for instance the sending of an SMS. A program is then activated and extracts from this buffer memory the parameter(s) (names of commands) and inserts them in the SMS message, more precisely in the field able to get parameters provided for this.

In other words, each leave with a highlighting concerning a proactive command of a given type will activate the same program that will be building the command according to the run-around made in the tree. For instance, a same SMS command generator will be used by all the tree leaves for which the selection requires sending an SMS.

As an advantage, it should be noted that when strolling, if a user goes from a lower level (n−1) to a higher level (n), a mechanism deletes from the buffer memory the name of the level (n−1) node.

### 2^{nd} Example of Embodiment

A second example of realisation illustrating this second solution is as follows. This second example illustrates the factorisation mechanism at the very centre of a command.

FIG. 10 shows a memory block of the CEA memory used to store a service. In this example, to simplify the description, the command indices and the corresponding commands have been represented in the same data block. Of course, the command indices and the commands could have been stored according to the breakdown described in reference to FIG. 6A or 7B, i.e. the indices in a zone Z2 and the commands in a zone Z3.

This service includes several commands (C1-C11) stored one after the other preferably without spaces between them in order to optimise the memory occupation. In our example of realisation, a field CH1 including all the command indices occupies the first bytes of this memory block.

Each command Cn has its own index and uses a decoding rule specific to the command type. Thus, depending on the user's reaction after executing a command Cx, the execution of this command may lead to various other commands, differentiated by their respective indices. For example, if a command concerns the entry of a PIN code by the user, the next command depends on whether the user enters the code correctly or incorrectly.

Consequently, an index must be stored in each command of the service for each potential future command.

The decoding rules for each command C3, C5, C8 involved in the execution of a particular command C1 must also be included in the byte string of the command C1 to be executed.

The number of bytes associated with a command may become very large.

FIG. 11 is a diagrammatic representation of an example where the execution of command C1 may lead to the execution of command C3, C5, or C8. This command therefore includes the indices of commands C3, C5 and C8 and their respective decoding rules.

We will consider the case, for example, when there are ten command types. Ten different rules are therefore required to decode the command byte string.

In order to illustrate this second example, we assume

that the execution of a command may result in the execution of at least 2 different commands from C3, C5 and C8;

and that the total number A of commands does not exceed 25 per service.

According to the principle of the solution, each command is replaced by a reference X (58,35,13) which will both

point directly in the field CH1 to obtain the index (OFFC3,OFFC5,OFFC8) of the next command to be executed, respectively;

and give the type Z of the command to be executed in order to execute the associated decoding rule.

Once the index of the command in question and its type have been found, the next command can be executed.

In our example, this reference is an artificial parameter marked X on FIG. 10. Preferably, this reference will have the least possible number of bytes to minimise the space required. It will depend on the maximum number possible for each command type.

The solution consists of using this reference X and of using two separate mathematical functions which can supply two results, one of which gives an index and the other a pointer to a decoding rule.

The range of possible values for this byte is then divided into equal intervals for each command type. A non-limiting way of determining the command types could be as follows:

if the reference X is from 0 to 24 inclusive, the command will be type 1,

if the reference X is from 25 to 49 inclusive, the command will be type 2, and so on.

In our example of realisation, the DIV operator will provide such a result. The command type is obtained by the mathematical operation:

Z=XdivA,

i.e., with A=25, Z=X div25

The mathematical operation

Y=XmodA,

i.e., with A=25, Y=X mod 25

is used to obtain the index of the next command to be executed in the field CH1 defined previously.

As a reminder, the properties of the DIV and MOD operators are as follows:

n DIV p=q: integer division of n by q gives the integer part of the quotient

n MOD p=r: modulo division of n by p gives the remainder r.

The present solution is not limited to these two types of mathematical operations.

This technique of factorising redundant information very much reduces the size of services and commands on the card. This technique enables both
a reduction of the number of SMS messages required to transmit from the SDB server to the card;
and a reduction of the memory space occupied by an application on the smart card.

This solution makes it possible to increase the number of services or applications within the card. This invention also enables a maximum reduction of the memory size required to manage this strolling between commands and also to free oneself from storing the identifier of the command shift decoding rule.

Generally speaking, the solution that optimises the memory space of the card is characterised in that each type of data is stored in different memory areas (Z2,Z3) of the said device. Each area has its own rule for updating.

It has been seen in our illustrated example that, if updating consists of deleting data, the microcontroler unit is programed for executing, when the type of data in an area (Z2) relates to a data position located in another area (Z3):
a shift in the memory to reorganise this area (Z2) so as to use back the freed memory space,
an updating of the positions taking into account the new positions further to the data shift in the said area (Z3).

Contrarily, when the data type of an area (Z3) relates to a service (Sn), the updating consists of making a shift of services in the (Z3) area so as to use back the freed memory space.

Preferably, each service (Sn) is identified by an identifier (Idn). Thus, when a command is received for updating data including this identifier (Idn), there remains to identify the various memory areas attached to the various types of data relating to this service.

This second solution obviously finds a good application in a smart card where the material constraints are very high, where the saving in memory space is very important. This second solution enables a reduction of the space required for ensuring strolling between proactive commands.

This second also concerns the process and the program for the execution of the steps of said process.

1. A data processing device, in particular a smart card, comprising a microcontroller storing various types of data (OFFn, Sn), wherein each type of data is stored in different memory areas (Z2, Z3) of the said device, and wherein said microcontroller is programmed to proceed, when updating the data in the memory of the said device, with an updating rule special for each area (Z2, Z3).

2. The device according to claim 1, wherein, if the updating consists of the deletion of data, the microcontroller is programmed so that, when the type of data in first area (Z2) relates to a data position located in a second area (Z3), the microcontroller executes
a memory shift operation to reorganise the first area (Z2) so as to recover memory space freed by the deletion of data,
an updating operation for updating references taking into account new positions the shift in the data in the first area (Z3).

3. The device according to claim 1, wherein if the updating consists of deleting data, the microcontroller is programmed so that, when the type of data in an area (Z3) relates to a service (Sn), it executes a shift of services in the area (Z3) so as to reclaim memory space freed by the deletion of data.

4. The device according to claim 3, wherein each service (Sn) is identified by an identifier (Idn), and wherein the microcontroller is programmed so that, when receiving a command for data updating including is the identifier (Idn), microcontroller identifies the various memory areas, attached to various types of data relating to this service.

5. An optimization process for the memory space operable to update data in a data processing device, in particular a smart card (SIM), storing various types of data (OFFn, Sn), comprising: a storing step for each type of data in different memory areas (Z2, Z3) of the said device, and when updating data in the memory of the said device, an updating step for updating each area (Z2,Z3) utilizing a rule special for each area (Z2, Z3).

6. The process according to claim 5, further comprising: if the updating consists of deleting data, and when the data type in an area (Z2) relates to a position of data located in another area Z3),
a shift step in the memory to reorganise this area (Z2) in order to reclaim memory space freed by the deletion of data,
a step for updating references by taking into account the new positions resulting from the shift in data in the said area (Z3).

7. The process according to claim 5, wherein, if the updating consists of data deletion and when the data type in an area (Z3) relates to a service (Sn), a step of shifting the services in the area (Z3).

8. (canceled)

9. A storage device comprising a computer program having program coding instructions for instructing a microcontroller to execute steps to:
store various types of data (OFFn, Sn), wherein each type of data is stored in different memory areas (Z2, Z3) of the microcontroller, and instructions directing the microcontroller to proceed, when updating the data in the memory of the said device, with an updating rule special for each area (Z2, Z3).

10. The storage device of claim 9 wherein the computer program further comprises instructions to:
if the updating consists of the deletion of data and when the type of data in a first area (Z2) relates to a data position located in a second area (Z3), to cause the microcontroller to execute
a memory shift operation to reorganise the first area (Z2) so as to recover memory space freed by the deletion of data,
an updating operation for updating references taking into account new positions the shift in the data in the first area (Z3).
